(19) United States
(12) Patent Application Publication
(10) Pub. No.: US 2009/0132438 A1
(43) Pub. Date: May 21, 2009

(54) PARCEL CARRIER BILLING SERVICE

(75) Inventors: David Dunmire, San Antonio, TX (US); Jeff Clark, San Antonio, TX (US); Chad Keith, St. Louis, MO (US)

Correspondence Address: AT&T Legal Department - JW;Attn: Patent Docketing, Room 2A-207, One AT&T Way, Bedminster, NJ, 07921, US

(73) Assignee: AT&T KNOWLEDGE VENTURES, L.P., Reno, NV (US)

(21) Appl. No.: 11/943,104

(22) Filed: Nov. 20, 2007

(51) Int. Cl. G07B 17/02; G01G 19/413; G06Q 30/00

(52) U.S. Cl. 705/407; 705/410

(57) ABSTRACT

A parcel carrier billing service includes a mobile unit for processing received parcels. Shipment parameters are received and used in calculating a postage that is assessed to a user account. The user account may be for a service provider network account that provides multimedia content such as Internet protocol based television services or broadband services. Notifications to the shipping party and recipient of the parcel may be sent upon receiving the parcel by the service and upon delivery of the parcel. Notifications may be sent via email, text message, or instant message chat sessions, as examples.

### BACKGROUND

1. Field of the Disclosure

The present disclosure generally relates to a billing service that may be associated with parcel carriers.

2. Description of the Related Art

Users that ship items through the mail or that use a parcel service are often responsible for calculating and attaching sufficient postage to the items.

### BRIEF DESCRIPTION OF THE DRAWINGS

FIG. 1 illustrates elements of an embodied parcel carrier billing system;

FIG. 2 illustrates representative operations relating to an embodied method; and

FIG. 3 depicts a data processing system in block diagram form that may be incorporated into disclosed embodiments.

### DESCRIPTION OF THE EMBODIMENT(S)

A disclosed embodiment relates to a computer program stored on a computer readable medium. The computer program has instructions operable for receiving first shipping parameters associated with a first parcel item. The first parcel item is from a first user location and the first user location corresponds to a first account. The computer program has instructions operable for calculating a first postage for the first parcel item based in part on the first received parameters. Further instructions are operable for associating the first postage with the first parcel item and assessing the first postage to the first account. Further instructions are operable for notifying a first recipient that the first parcel item has been received for transport and is destined for the first recipient. The computer program has instructions operable for notifying a first sender that the first parcel item has been received for transport and is destined for the first recipient, wherein the first sender is associated with the first account. Further instructions are operable for receiving second shipping parameters associated with a second parcel item. The second parcel item is from a second user location and the second user location corresponds to a second account. Further instructions are operable for calculating a second postage for the second parcel item based in part on the second received parameters. Other instructions are operable for associating the second postage with the second parcel item and assessing the second postage to the second account. The computer program has instructions operable for notifying a second recipient that the second parcel item has been received for transport and is destined for the second recipient and notifying a second sender that the second parcel item has been received for transport and is destined for the second recipient, wherein the second sender is associated with the second account.

Other embodiments relate to a method for assessing a postage charge for a transport service. The method includes receiving a request to pick up a parcel at a site requested by the user. The method further includes receiving at least one shipment parameter for transporting the parcel and calculating the postage charge. The postage charge is based in part on at least one shipment parameter and the postage charge is based in part on at least one predetermined parameter. The method includes assessing the postage charge to a user account. The user account corresponds to a user and assessing the postage charge to the user account includes a mobile module associated with the transport service communicating through a network with the billing module. The method includes associating the required postage with the parcel and receiving the parcel for transport.

Another embodiment relates to a parcel carrier billing system including a mobile unit for processing a received parcel. The received parcel is for sending to a recipient. The mobile unit includes a first data processing system enabled for processing at least one shipment parameter associated with the received parcel. The parcel carrier billing system includes software stored on a computer readable medium having instructions operable for calculating a postage charge. The postage charge is based in part on the at least one shipment parameter. The software has instructions operable for assessing the postage charge to an account associated with the user and initiating notification to the user that the parcel has been received. Further instructions are operable for initiating notification to the recipient that the parcel has been received.

In the following description, for the purposes of explanation, numerous specific details are set forth in order to provide a thorough understanding of the disclosed embodiments. A person of ordinary skill in the art should recognize that embodiments might be practiced without some of these specific details. In other instances, well-known structures and devices may be shown in block diagram form or omitted for clarity.

Disclosed embodiments relate to a parcel carrier billing service that may be implemented in software stored on a machine or computer readable medium and enabled to facilitate postal carriers and transport companies (e.g., United States Post Office, private overnight delivery companies, etc.) in collecting items for delivery that may not have postage attached prior to using the service. The term “postage,” as used herein may refer to any charge associated with delivering an item to the intended destination. In accordance with disclosed embodiments, postage may also include a charge associated with picking up the item from a home or business. Any combination of stamps, labels, radio-frequency identification tag, holograms, bar codes, magnetic strips, or other printed matter attached to an item may either provide billing information for future payment or provide evidence of a completed payment of such postage. The term “postal carrier” may be used in this description as an illustrative example, but this term is not intended to limit the subject matter of the claims. Other delivery services and personnel may utilize or be a part of disclosed embodiments. For example, dry cleaning services that pick up clothes from household units or living units (i.e., homes) or businesses may utilize disclosed embodiments to automate the process of picking-up clothes, determining preferences for a customer, associating billing parameters and preferences with the picked up clothes, and automatically billing the customer for the services through a centralized, networked system. Accordingly, the term “parcel” is used in this description for illustrative purposes only and may describe clothes in need of dry cleaning, clothes in need of altering, items in need of delivery, items in need of repair, pets in need of grooming, and other items that may be picked up by any “postal carrier,” as the term is used in this disclosure.

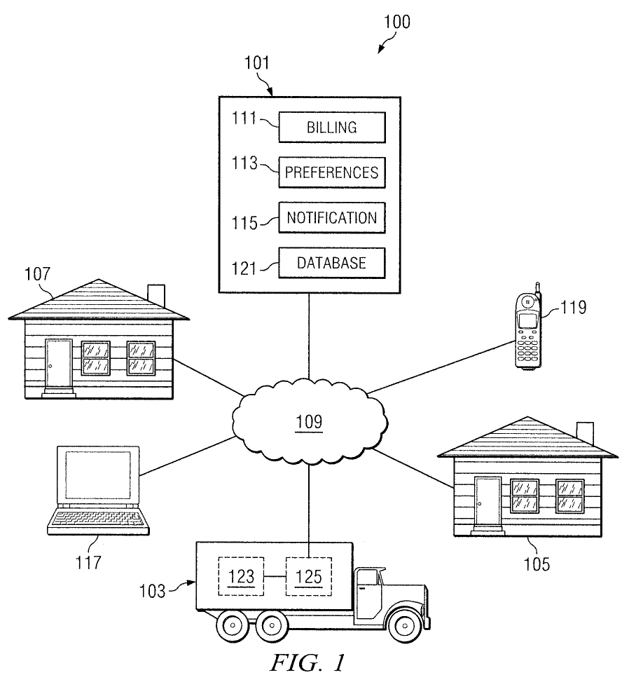

FIG. 1 illustrates elements of an environment 100 for operation of a parcel carrier billing system. A parcel carrier vehicle 103 includes a mobile unit 123 for processing a received parcel (not shown) that may be received from a first household unit 107 that is associated with a first user (i.e., the shipping party). In some embodiments, the first user is associated with a first account, which may be an account associated with a service provider network such as an Internet protocol television (IPTV) network or other network for providing multimedia content to first household unit 107. The first user may send a notification via email, telephone call, text message, instant message chat, or other means for requesting that parcel carrier vehicle 103 go to first household unit 107 to pick up a parcel for transport. In some embodiments, a first user may specify a remote location relative to the first user's household unit for retrieving a package or parcel. For example, the first user associated with household unit 107 may instruct the parcel carrier vehicle 103 to retrieve a package or parcel from second household unit 105. The first user associated with household unit 107 may contact parcel carrier vehicle 103 or a server associated with parcel carrier vehicle 103 using mobile telephone 119 or personal computer 117, as examples. As shown, communication between the first user of household unit 107 and the parcel carrier vehicle 103 may occur over network 109. Similarly, parcel carrier vehicle 103 may communicate with a software product 101 and associated modules through network 109. Software product 101 is stored on a computer readable medium (not shown) and may include instructions including billing module 111, preferences module 113, notification module 115, and database 121.

Billing module 111 has instructions for determining postage associated with a parcel. In determining postage, billing module 111 may use parameters collected from mobile unit 123. Mobile unit 123 may be, for example, a device used for measuring the size and weight of a package or parcel. Mobile unit 123 may also receive manual input from an operator associated with parcel carrier vehicle 103 regarding the size, weight, or other shipment parameters associated with the retrieved parcel. In some embodiments, mobile unit 123 may utilize a global positioning system (GPS) for associating a retrieved parcel with a physical location such as a street address for a first user. For example, parcel carrier vehicle 103 may use GPS technology to associate automatically a retrieved parcel with a street address for household unit 107. In some embodiments, mobile unit 123 and associated software modules may determine the distance to a recipient's location (for example, household unit 105) using map software and a starting address automatically obtained by mobile unit 123.

Parcel carrier vehicle 103 includes, as shown, communication unit 125 for communicating over network 109. As shown, communication unit 125 is communicatively coupled to mobile unit 123 and network 109. Communication unit 125 may use mobile technology that is commonly used in mobile telephone, wireless data, WiMAX, or WiFi networks. In some embodiments, communication unit 125 receives and sends data using local area networks associated with household units (e.g., first household unit 107 or second household unit 105) using wireless technology such as WiFi.

In some embodiments, mobile unit 123 may calculate postage for a received parcel item based in part on received parameters. Mobile unit 123 may include a data processing system communicatively coupled to a computer readable medium with instructions operable for receiving shipping parameters, calculating charges associated with the shipping parameters and other factors including then-current shipping rates. Further, mobile unit 123 may have instructions for calculating and associating a postage charge with a user account associated with a shipper. Mobile unit 123 may be enabled for initiating notification communications with a sender (i.e., shipper or shipping party) to inform the sender that a parcel has been retrieved and postage has been assessed to the sender's account. Mobile unit 123 may also be enabled for initiating a notification communication to a parcel recipient that a parcel that is destined for the recipient has been retrieved and is in transit. In addition to receiving parcels from a first user, parcel carrier vehicle 103 may receive parcels from other household units, government entities, or businesses.

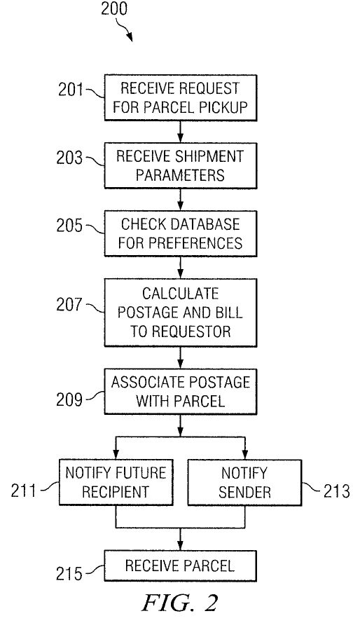

FIG. 2 illustrates methodology 200 that, as shown, relates to an embodied parcel carrier billing service. In optional operation 201, a parcel carrier receives a request for parcel pickup. Operation 201 may be optional in situations including when the parcel carrier makes periodic stops at a user's household unit or business without a specific request. In other cases, a request may be automatically generated by a user when parcel service is needed. On the contrary, when parcel service is not needed, embodiments may generate an automatic request that parcel pickup not occur. Such a feature in a parcel carrier billing service may help reduce a parcel carrier's travel costs and any waste of other resources in the event a household unit or business had no parcels for delivery or pickup on a particular day.

In operation 203, the parcel carrier receives shipment parameters regarding the parcel. Shipment parameters may include the weight and dimensions of a parcel. In some cases, shipment parameters may include the content type of the package. For example if the content type is a hazardous chemical, then certain precautions may need to be taken for shipment. As another example, the shipment may either include perishable or fragile items that require special treatment. Accordingly, operation 203 considers the shipment parameters associated with a parcel. A database such as database 121 (FIG. 1) may be accessed automatically in processing shipment parameters to determine costs and times associated with delivery of a parcel, for example. In some embodiments, operation 203 may relate to a parcel carrier measuring the dimensions and weighing a parcel in a parcel delivery vehicle (e.g., parcel carrier vehicle 103, FIG. 1) that uses remote equipment communicatively coupled to a centralized parcel processing application. In addition, as part of operation 203, a parcel carrier operator (e.g., a delivery driver or postal worker) may manually input shipment parameters such as the destination address, the parcel weight, and the parcel size.

As illustrated in FIG. 2, operation 205 relates to the parcel carrier checking a database (e.g., database 121, FIG. 1) for user preferences. For example, operation 205 may include accessing predetermined preferences stored by a user (e.g., resident of a household unit) of an embodied parcel carrier billing service that often ships parcels using the same preferences regarding mode of transportation, insurance, speed of delivery, and the like. Such preferences may be obtained by accessing a preferences module such as preferences module 113 (FIG. 1) or/by accessing database 121 (FIG. 1). Preferences accessed by preference module 113 may include, as examples, insurance preferences, notification preferences, return receipt preferences, mode of transportation preferences, and possibly preferences regarding the particular carrier that should be used in transporting and delivering a package. In addition, preferences module 113 may access billing preferences and any other predetermined parameters that may be accessed by operation 205. In some embodiments, in the event of inclement weather in some areas, operation 205 may consider whether there are any closed shipping routes and possibly consider a user's preferences regarding actions to be taking during any closed shipping routes. In some embodiments, a user may store preferences such as “fastest delivery possible” or “cheapest method possible” within their preferences. In other cases, a particular destination may have a first preference stored and a second destination may have a second preference stored regarding mode of transport, speed of delivery, or the like.

As shown in FIG. 2, operation 207 includes calculating postage and billing the user or shipper and operation 209 includes associating the calculated postage with the applicable parcel. In some embodiments, postage calculations may be performed by a billing module such as billing module 111 (FIG. 1). In some embodiments, associating the postage with the applicable parcel may include affixing a label or other indicative of the amount of postage or indicative that postage has been collected for the applicable parcel. In addition, in some embodiments, a data processing system remote from a delivery enterprise's office and localized to a delivery vehicle executes software stored on a computer readable medium for calculating the postage using information obtained from a billing module (e.g., billing module 111, FIG. 1) or other database (e.g., database 121, FIG. 1). As shown, operation 207 includes billing the shipping party or an account associated with the shipping party. In some embodiments, an account to be billed is not necessarily associated directly with the parcel carrier or enterprise providing the pick up and transport services. In other words, the billing service may be hosted by a separate enterprise such as a multimedia service provider network. The multimedia service provider network may have an agreement with the parcel carrier to coordinate the billing, notifications, and other factors related to the automated process of picking up parcels and billing for the service. In some embodiments, the multimedia service provider may collect a fee from the user associated with a parcel and provide a monetary credit to the parcel carrier. Status notifications to senders and recipients of parcels may be sent by the service provider network to mobile telephone devices, personal digital assistants, personal computers, set-top boxes that assist in the delivery of multimedia content to a household unit, and other such devices. In some embodiments, a parcel carrier billing service may charge flat rate fees for a time period instead of billing for each delivery. To this end, parcel carriers and their partners may provide embodied systems on a subscription service or otherwise as part of a monthly service, weekly service, or annual service for which a flat fee is charged. Such systems would promote a consistent revenue stream for providers that were independent of what otherwise may involve swings in delivery revenue that may be influenced, for example, by holidays.

Accordingly, embodiments relate to delivery and transport services that collect parcel items and other materials and bill for the services automatically, without requiring direct communication with the shipping party (i.e., user) and parcel enterprise responsible for pick-up, transport, and delivery. Customers no longer have to pre-purchase postage or guess what the correct postage is. In the event of a postage increase, embodied systems would reduce the need to buy additional stamps or postage to make up for stamps that were no longer usable alone. Embodied systems may also allow for different billing options than what many other widely-adopted delivery services offer. For example, some embodied systems permit billing after the fact of delivery. In addition, some embodied systems allow for billing flat rates for a particular week, month, or year. Further, some embodied systems provide a means to indicate to a customer that their physical mail or parcel item has been picked up or delivered (operation 211) or to indicate to a recipient that the applicable physical mail or parcel item has been picked up for delivery (operation 213). Customers using embodied systems have the option to put their delivery requests in their mail box and know they will be billed the minimum amount correctly. Embodied systems permit postal carriers to provide new billing models and services that provide an easy, consistent experience for the customer, which promotes repeat business. In operation 215, the recipient receives the parcel. Delivery services may provide a customer with notification regarding shipment particulars (i.e., pick up, postage, and delivery particulars) on their personal computer, personal digital assistant, telephone, or television, as examples.

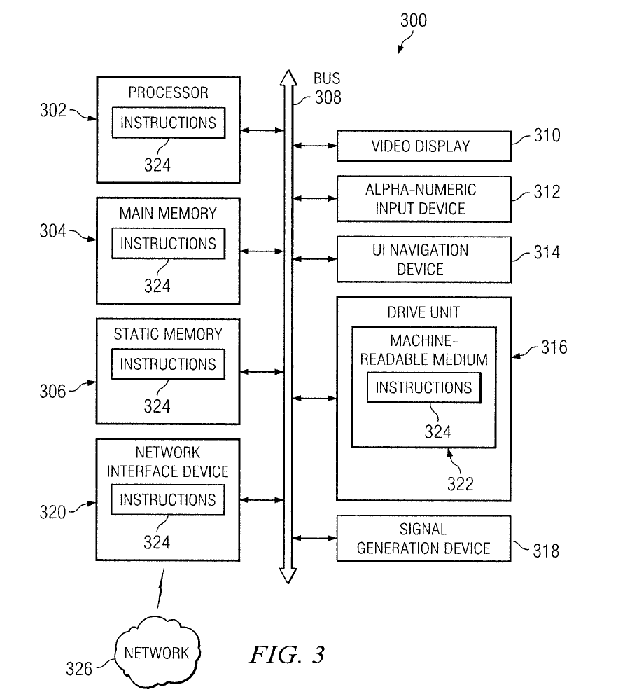

FIG. 3 is a diagrammatic representation of a machine (i.e., data processing system) in the example form of a computer system 300 within which a set of instructions for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a digital video recorder (DVR), a personal computer (PC), remote module for processing shipment parameters, a tablet PC, a set-top box (STB), a cable box, a satellite box, an electronic programming guide box, a Personal Digital Assistant (PDA), a residential gateway, a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 300 includes a processor 302 (e.g., a central processing unit (CPU), a graphics processing unit (GPU) or both), a main memory 304 and a static memory 306, which communicate with each other via a bus 308. The main memory 304 and/or the static memory 306 may be used to store the channel history data. The computer system 300 may further include a video display unit 310 (e.g., a television, a liquid crystal display (LCD) or a cathode ray tube (CRT)) on which to display broadcast or other programs, for example. The computer system 300 also includes an alphanumeric input device 312 (e.g., a keyboard or a remote control), a user interface (UI) navigation device 314 (e.g., a remote control, or a mouse), a disk drive unit 316, a signal generation device 318 (e.g., a speaker) and a network interface device 320. The input device 312 and/or the navigation device 314 (e.g., the remote control) may include a processor (not shown), and a memory (not shown). The disk drive unit 316 includes a machine-readable medium 322 on which is stored one or more sets of instructions and data structures (e.g., software 324) embodying or utilized by any one or more of the methodologies or functions described herein. The software 324 may also reside, completely or at least partially, within the main memory 304 and/or within the processor 302 during execution thereof by the computer system 300.

The software 324 may further be transmitted or received over a network 326 (e.g., a television cable provider) via the network interface device 320 utilizing any one of a number of well-known transfer protocols (e.g., broadcast transmissions, HTTP). While the machine-readable medium 322 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the disclosed methodologies or that is capable of storing, encoding or carrying data structures utilized by or associated with such a set of instructions. The term “machine-readable medium” shall accordingly be taken to include, but not be limited to, solid-state memories, optical and magnetic media, and carrier wave signals.

While the disclosed systems may be described in connection with one or more embodiments, it is not intended to limit the subject matter of the claims to the particular forms set forth. On the contrary, it is intended to cover such alternatives, modifications and equivalents as may be included within the spirit and scope of the subject matter as defined by the appended claims.

What is claimed is:

1. A computer program stored on a computer readable medium, the computer program having instructions operable for:
receiving one or more shipping parameters associated with a parcel item, wherein the parcel item is from a user location, and wherein the user location is associated with an account;
calculating a postage for the parcel item based in part on the one or more received shipping parameters;
assessing the postage to the account;
notifying a recipient that the parcel item is destined for the recipient; and
notifying a user that the parcel item is destined for the recipient, wherein the user is associated with the account, and wherein the account is associated with providing multimedia content to the user location.

2. The computer program of claim 1, further having instructions operable for:
accessing a database for user preferences associated with the account; and
applying the user preferences to determine a mode of transportation for transporting the parcel.

3. The computer program of claim 1, wherein the one or more shipping parameters include a measured weight for the parcel item.

4. The computer program of claim 1, further having instructions operable for:
receiving a request to pick up the parcel item at the user location.

5. The computer program of claim 1, wherein the parcel item is received by a first transporting enterprise, and wherein the account is associated with a service provider network for providing multimedia content.

6. The computer program of claim 5, further having instructions operable for:
providing to the first transporting enterprise a monetary credit corresponding to the postage.

7. A method of processing postage charges for a transport service, the method comprising:
receiving a request to pick up a parcel at a site requested by a user;
receiving at least one shipment parameter for transporting the parcel;
calculating the postage charge, wherein the postage charge is based in part on the at least one shipment parameter and in part on at least one predetermined parameter;
assessing a postage charge to a user account, wherein the user account is associated with providing multimedia content to the site, and wherein assessing the postage charge to the user account includes a mobile module associated with the transport service communicating through a network with a billing module; and
receiving the parcel for transport.

8. The method of claim 7, wherein the parcel is a letter.

9. The method of claim 7, wherein the parcel includes clothes.

10. The method of claim 7, wherein the parcel is a package.

11. The method of claim 7, further comprising:
accessing a database for stored preferences corresponding to the user.

12. The method of claim 7, further comprising:
notifying the user upon the parcel being received for transport.

13. The method of claim 12, wherein the transport service is for delivering the parcel from a first location designated by the user to a second location, the method further comprising:
notifying a recipient associated with the second location upon the parcel being delivered to the second location.

14. The method of claim 13, further comprising:
notifying the recipient upon the parcel being received for transport.

15. The method of claim 14, further comprising:
accessing one or more user preferences.

16. The method of claim 13, wherein notifying the user that the parcel has been received occurs by email.

17. A parcel carrier billing system comprising:
a mobile unit for processing a received parcel, wherein the received parcel is received from a location associated with a user, wherein the received parcel is for transport to a recipient, and wherein the mobile unit includes:
a data processing system enabled for:
processing at least one shipment parameter associated with the received parcel;
wherein the parcel carrier billing system includes software stored on a computer readable medium, the software having instructions operable for:
calculating a postage charge, wherein the postage charge is based in part on the at least one shipment parameter;
assessing the postage charge to an account associated with the user, wherein the account associated with the user is associated with providing multimedia content to the location associated with the user;
initiating notification to the user that the parcel has been received; and
initiating notification to the recipient that the parcel has been received.

18. The parcel carrier billing system of claim 17, wherein the mobile unit further includes:
a scale for weighing the received parcel, wherein the at least one shipment parameter includes a weight of the parcel.

19. The parcel carrier billing system of claim 17, wherein the at least one shipment parameter includes at least one size parameter of the parcel.

20. The parcel carrier billing system of claim 17, wherein the at least one shipment parameter includes a content type associated with the received parcel item.

21. The parcel carrier billing system of claim 17, wherein the software further has instructions operable for:
accessing one or more shipment preferences associated with the user; and
applying the shipment parameters to determine a mode of transportation for the parcel item.

22. The parcel carrier billing system of claim 17, wherein notification to the user that the parcel has been received is sent to an email address.
